(19) United States
(12) Patent Application Publication
(10) Pub. No.: US 2023/0062743 A1
(43) Pub. Date: Mar. 2, 2023

(54) METHOD FOR MAKING A STAND-UP ENVELOPE AND RELATIVE MACHINE FOR MAKING SAID ENVELOPE

(71) Applicant: UNIVERSAL PACK S.R.L., San Giovanni In Marignano (IT)

(72) Inventor: Pietro Donati, San Giovanni In Marignano (IT)

(73) Assignee: UNIVERSAL PACK S.R.L., San Giovanni In Marignano (IT)

(21) Appl. No.: 17/799,650

(22) PCT Filed: Jan. 29, 2021
(86) PCT No.: PCT/IT2021/050024

§ 371 Date: Aug. 12, 2022

(30) Foreign Application Priority Data
Feb. 12, 2020 (IT) 102020000002812

(51) Int. Cl. B31B 70/84; B65B 5/02; B65B 61/18

(52) U.S. Cl. CPC B31B 70/844; B65B 5/022; B65B 61/186; B31B 2160/20

(57) ABSTRACT

A method to produce a stand-up pouch (S) provides to make available at least one pre-shaped pouch (PS) initially having a flat configuration, which is defined by a lateral wall (111), by a bottom wall (112) and is provided with at least one hole (113), the pre-shaped pouch (PS) being accessible in correspondence with an aperture (114) opposite the bottom wall (112), the pre-shaped pouch (PS) being positioned so that the hole (113) is aligned with respect to an axis of insertion (Z). The method then provides to manipulate the pre-shaped pouch (PS) by means of holding and shaping means (15, 16) so as to shape the pre-shaped pouch (PS) so as to make available a containing chamber (V) thereof, and to move an insertion rod (13) along the axis of insertion (Z), through the aperture (114), inside the containing chamber (V) just defined, in order to position, and temporarily hold in position, a delivery mean (117) in correspondence with the hole (113).

### FIELD OF THE INVENTION

The present invention concerns a method to produce a stand-up pouch starting from a pre-shaped pouch provided with a hole for positioning a nozzle able to engage with a closing cap of the pouch.

The pre-shaped pouch can be made of a flexible material, for example a single-layer or multi-layer material, for example laminar, thick enough to allow the stand-up pouch, when filled with a substance or product, not to deform due to the weight and/or thrust of the product contained inside it, and to remain in an upright position.

### BACKGROUND OF THE INVENTION

Machines are known for the production of so-called primary packaging such as pouches, bags, or in general packages intended to receive and contain bulk products either solid, liquid or powder which, by way of example only, can be drugs, supplements, foods, granules, seeds, creams, detergents or other.

Of particular interest in the primary packaging sector are the so-called stand-up pouches provided with a particular shape that allows the pouch to be kept in a stable balanced position and allows them to self-support in an upright position. This type of solution is highly appreciated by end consumers, since it is very efficient, convenient and extremely practical.

Although there are different types of stand-up pouches, having a configuration depending on the type of products to be contained and/or on the methods of use and/or storage of the products themselves, they typically comprise a lateral containing wall that may have folding lines or bellows able to increase the volume of the pouch after the product has been inserted, a bottom wall and an opposite upper wall, one of which can, in some known embodiments, act as a support base for the pouch itself.

The stand-up pouch is provided with a nozzle to which a cap is applied, for example by screwing or pressure. The nozzle allows to deliver the product contained inside the pouch and in some cases also to fill it. The nozzle can be disposed in a central position, on the bottom wall or on the upper wall, or in an off-center position on the lateral wall. When the nozzle is disposed in a central position and the cap has a sufficiently large resting surface, it can act as a support base for the pouch itself.

Methods for producing stand-up pouches are known, which typically start from the supply of a band of continuous film made of heat-sealable flexible material wound in rolls. Such methods provide a large number of operating steps and for this reason are very complex and particularly subject to malfunctions, or very often produce defective or non-conforming pouches. Furthermore, these methods require very large machines given that the operating flow passes through numerous operating stations before obtaining the finished pouch.

An example of such a method is described in US patent document 8,790,229 B2 in which, in a preliminary step, a series of holes are made on a band of film of heat-sealable material for the insertion of a respective spout or nozzle. The band of film is then subjected to a series of folds that define the final shape of the pouches. The folded band is flattened by a series of rollers and forced to advance toward the hot sealing stations. Once the transverse seal has been made, cutting means separate the pouches which advance one at a time toward the subsequent stations which complete the process. Once the pouch is completed, it is filled through the spout, by conventional filling means, and then sealed with a cap.

This method is very complicated and requires a large number of operating steps. Furthermore, applying the nozzle before forming the pouches can cause the band of film to get stuck during the production of the folds and/or during its advance toward the sealing and cutting stations.

WO 86/06344 discloses a method to attach a nozzle in a horizontal machine of the “form/fill/seal” type, which provides to feed a film of heat-sealable material, folded in two, in a horizontal direction of feed, to perform vertical seals in order to delimit two successive containers, to partly cut this vertical seal in order to partly separate the subsequent containers, and then to apply a nozzle to them by sealing. In particular, the sealing takes place by inserting one of either a nozzle insertion member or a sealing element inside a newly formed container. The thrust exerted by the element inserted longitudinally into the container determines the formation of a bottom wall of the container, on which the nozzle is attached. This means that two containers thus obtained do not have the bottom wall with the same shape.

This document does not provide to make available a pre-shaped container including a bottom wall in which a hole has already been made to accommodate the nozzle. Making this hole constitutes an additional step to the succession of numerous steps already provided, which makes the process more complex and expensive.

There is therefore a need to perfect a method to produce a stand-up pouch and corresponding machine for producing said pouch which can overcome at least one of the disadvantages of the state of the art.

In particular, one purpose of the present invention is to perfect a method to produce a stand-up pouch which is simple and requires a limited number of operating steps.

Another purpose of the present invention is to perfect a method to produce a stand-up pouch which allows to limit or prevent the pouch getting stuck as it advances between the operating stations.

Another purpose is to provide a machine to implement the method to produce a stand-up pouch.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a method to produce a stand-up pouch, which overcomes the limits of the state of the art and eliminates the defects present therein, equipped with a delivery mean configured to allow the delivery of substances or products intended to be contained in the pouch, provides to:
make available, in a station for shaping the pouch, at least one singularized and pre-shaped pouch initially having a flat configuration and being defined by a lateral wall and by a bottom wall provided with at least one hole. The pre-shaped pouch is accessible in correspondence with an aperture opposite the bottom wall, and is positioned so that the hole is disposed along an axis of insertion of the delivery mean;
manipulate the pre-shaped pouch by means of holding and shaping means so as to shape the pre-shaped pouch defining a containing chamber thereof;
move an insertion rod along the axis of insertion, through the aperture, inside the containing chamber just defined, in order to position, and temporarily hold in position, a delivery mean in correspondence with the hole.

We wish to clarify that by ‘singularized pouch’ we mean, in the context of this application, an individual pouch, which is not connected to or integral with other pouches. Furthermore, by ‘pre-shaped pouch’ we mean that the pouch has already been previously shaped, that is, folded, sealed, shaped, perforated and possibly suitably flattened.

This method allows to considerably simplify the production of a stand-up pouch because it reduces the number of operating steps required. Furthermore, associating the delivery mean directly with the pre-shaped pouch, and not during its production step, allows to eliminate the possible problems related to the movement of such an assembly. In fact, the presence of the delivery mean already in the preliminary production steps of the pouch makes moving it much more complicated since it increases the probability that it will possibly become stuck with the members used to feed the pouches along the processing line.

Some embodiments described here also concern a machine for producing a stand-up pouch able to carry out the method described above. The machine comprises at least one shaping station provided at least with:
holding and shaping means configured to shape a singularized pre-shaped pouch defining a containing chamber thereof,
an insertion rod having a development along an axis of insertion and being mobile along the axis of insertion in order to position, and temporarily maintain in position, inside the containing chamber a delivery mean in correspondence with a hole provided in a bottom wall of the pre-shaped pouch.
   Advantageously, the machine for producing a stand-up pouch is not equipped with a station for feeding a film of material for producing the pouch, a station for folding the film, a station for sealing the film and a station for perforating the film.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic front view, which shows a pre-shaped pouch in a flat configuration and an insertion rod;

FIG. 1a is a bottom view of the pre-shaped pouch of FIG. 1;

FIG. 2 is a schematic view that shows a partly open pre-shaped pouch and the insertion rod of FIG. 1, carrying a delivery mean to be inserted in the pouch;

FIG. 2a is a plan view, from below, which schematically shows the step of opening the pre-shaped pouch in order to make its containing chamber available;

FIG. 3 is a schematic and section front elevation view that shows an operative step of positioning the delivery means in the hole located on the bottom wall of the pre-shaped pouch;

FIG. 3a is a bottom view of FIG. 3;

FIG. 4 is a view like that of FIG. 3 that shows the step of sealing the delivery mean to the bottom wall of the pre-shaped pouch;

FIG. 4a is an enlarged detail of FIG. 4;

FIG. 5 is a view like that of FIG. 3 that shows a sequence following that of FIG. 4 in which the sealing means and the insertion rod move away from the pouch;

FIG. 6 shows an example embodiment of a stand-up pouch produced with the method according to embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF SOME EMBODIMENTS

We will now refer in detail to the possible embodiments of the invention, of which one or more examples are shown in the attached drawings. Each example is supplied by way of illustration of the invention and shall not be understood as a limitation thereof. For example, one or more characteristics shown or described insomuch as they are part of one embodiment can be varied or adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

Embodiments described here concern a machine for producing a stand-up pouch S and a corresponding method to produce a stand-up pouch S, as will be described in more detail below. It is understood that some embodiments of the machine can provide a plurality of processing units, disposed in respective stations able to execute the steps of the method in accordance with the present invention, wherein such stations can be disposed in a single compartment defined inside the machine, or in separate and communicating compartments. In any case, there can be provided suitable means for manipulating the pouches S, capable of transferring them from one station to another, and possibly from one compartment to another.

The machine described is configured to produce stand-up pouches S starting from a pre-shaped and singularized, that is, individual, pouch PS. In other words, the machine described here is preferably separated from the machine in which the pre-shaped pouch PS is prepared.

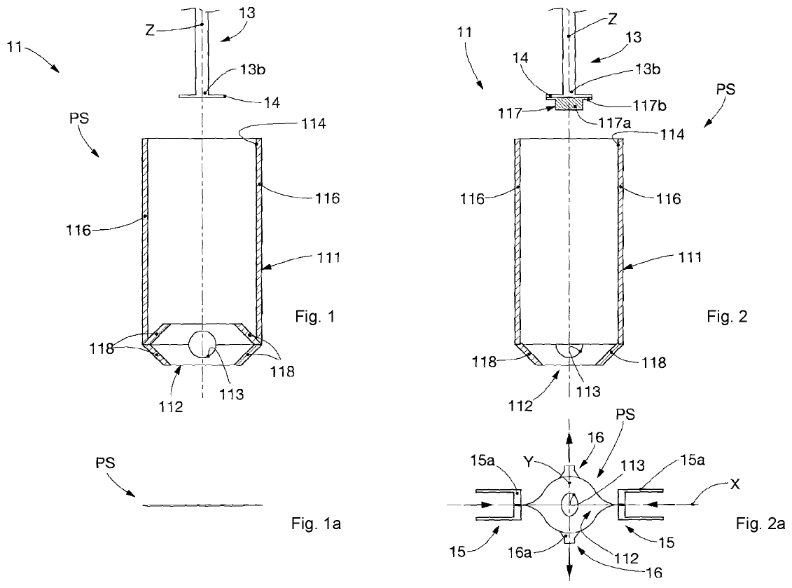

As can be seen from FIG. 1, the pre-shaped pouch PS that is fed to the machine has been previously produced, for example through subsequent processing steps that provide to feed, fold, seal and cut the film in order to produce the pre-shaped pouches PS, each one separated from the others. The production of the pre-shaped pouches PS also provides to perforate these pouches so that they are provided with a through hole, as explained in greater detail below, in order to flatten the pre-shaped pouches PS.

In one embodiment, the machine comprises at least one shaping station 11 able to shape a pre-shaped pouch PS, and at least one sealing station 12 configured to irreversibly associate a delivery mean 117 with the pre-shaped pouch PS. Advantageously, the shaping station 11 and the sealing station 12 can define a single shaping and sealing station, thus allowing to reduce the bulk of the machine to a minimum. This is also advantageous because, as will become clear hereafter, some components present in the shaping station 11 can also be functionally operative in the sealing station 12.

The shaping station 11 is suitable to receive one or more pre-shaped pouches PS directly from a machine dedicated to producing the pouches S located upstream of the machine in question, or from a storage warehouse of such pre-shaped pouches PS.

The shaping station 11 can comprise means (not shown) for introducing the pre-shaped pouches PS, which can be supplied individually or in groups of two or more individual units. For example, the pre-shaped pouches PS can be collected in sorted stacks, and each stack can be fed to the introduction means as above. In this way, the shaping station 11 can be continuously fed and the method to produce the stand-up pouches S can be implemented without interruptions or at least with reduced machine set-up times.

In accordance with some embodiments described here, the pre-shaped pouches PS comprise a lateral wall 111, a bottom wall 112 provided with a hole 113 and an opposite aperture 114, having, preferably but not exclusively, a size approximately equal to the width of the pre-shaped pouch PS. It should be noted that the bottom wall 112 is preferably already shaped and provided with the hole 113, even if it is initially oriented parallel to the rest of the flattened pre-shaped pouch PS. In particular, and advantageously, the bottom wall 112 is already flat or substantially flat.

The bottom wall 112 can have a central fold 115 and the hole 113 can be disposed symmetrically across the central fold 115. The central fold 115 defines two portions of the bottom wall 112 which are located, at least initially, opposite each other coplanar in the vertical direction. The lateral wall 111 can be defined by at least one pair of opposite faces coupled to each other. In this way, the pre-shaped pouch PS can have, at least initially, a substantially flat configuration, as shown in FIG. 1a. This simplifies the storage and manipulation of the pre-shaped pouches PS.

The pre-shaped pouch PS can have one or more lateral sealing lines 116, able to seal together two or more of the faces defining the lateral wall 111, and one or more bottom sealing lines 118 able to seal the bottom wall 112 with the lateral wall 111.

The lateral wall 111 and the bottom wall 112 define a containing chamber V able to receive and contain a product or a substance, at the end of the production process of the pouch S. In particular, the distance between the lateral sealing lines 116, measured inside the containing chamber V, can be approximately equal to the size of the aperture 114.

The bottom wall 112 has a surface such as to define, when the pre-shaped pouch PS is shaped, the base area of the containing chamber V, while the lateral wall 112 has a longitudinal development substantially defining the height of the containing chamber V. In accordance with some embodiments, the shaping station 11 and the sealing station 12 comprise an insertion rod 13 which develops along an axis of insertion Z.

In accordance with some embodiments, the direction of the axis of insertion Z can be parallel to a vertical, horizontal or inclined axis, and depending on the configuration there can be provided suitable mechanical support means in order to keep the pouch S in the correct position.

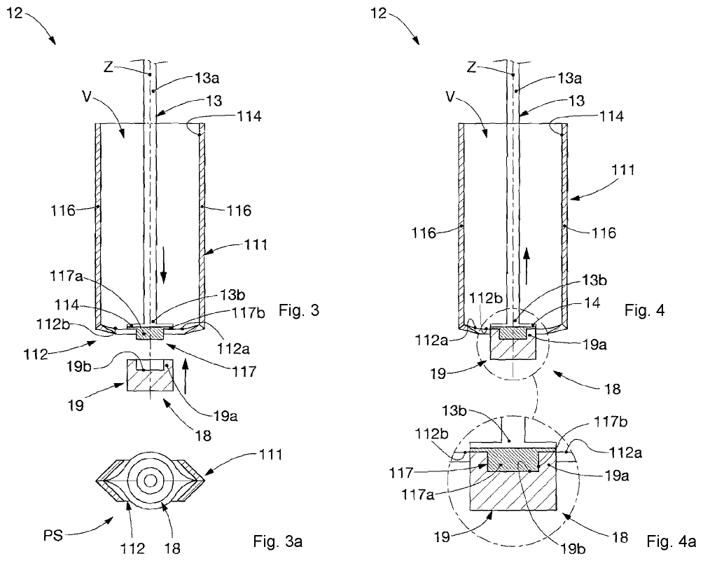

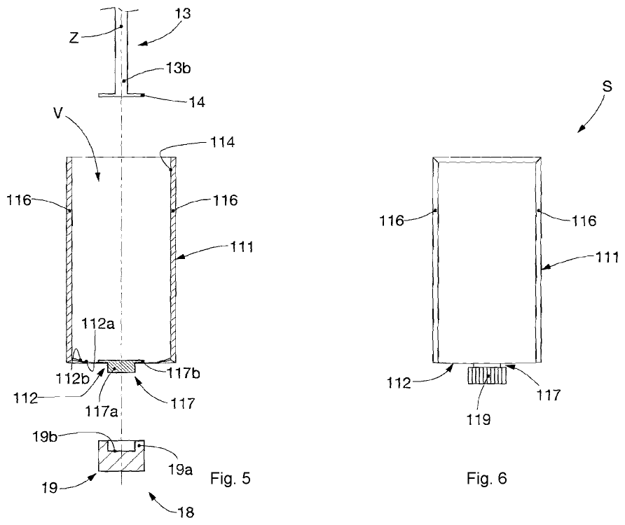

The insertion rod 13 has an actuation end 13a (FIGS. 3 and 4) which can be operatively associated with an actuation device, configured to transmit at least one translational motion to the insertion rod 13 along the axis of insertion Z, and an opposite operative end 13b equipped with gripping and positioning means 14.

The gripping and positioning means 14 are configured to hold and position the delivery mean 117 in correspondence with the hole 113 of the pre-shaped pouch PS. The hole 113 is centered with respect to the axis of insertion Z, and the latter coincides with the axis of symmetry of the hole 113, in the embodiment described here in which the hole 113 has a circular shape.

The gripping and positioning means 14 can be selected from a group comprising suckers, releasable mechanical holding devices, magnetic devices, in the event that the delivery mean is made of metal or contains metal parts, or other.

The insertion rod 13 is configured to pass from a remote position, in which the operative end 13b is disposed outside the pre-shaped pouch PS (FIGS. 1 and 2), to an insertion and contrast position, in which the operative end 13b is disposed in the containing chamber V and the gripping and positioning means 14 place the delivery mean 117 and temporarily keep it in position in correspondence with the hole 113 (FIGS. 3 and 4). In the example described here, the axis of insertion Z is vertical and the insertion rod 13 enters the pre-shaped pouch PS from above, while the sealing means 18 operate from below, or vice versa.

According to some embodiments, with particular reference to the attached drawings, the delivery mean is configured as a nozzle 117.

Here and hereafter in the description the term “nozzle” 117 identifies a hollow element provided with a neck 117a configured to put the containing chamber V of the pouch S in communication with the outside, in order to determine the delivery of the product contained therein, and with a positioning plate 117b suitable to be positioned on, and permanently attached to, an internal surface 112a of the bottom wall 112 on the side of the containing chamber V, around the hole 113. In particular, the positioning plate 117b defines a perimeter support edge, for example circumferential, around the neck 117a. The perimeter support edge has a transverse size, for example a diameter, greater than the transverse size, for example the diameter, of the hole 113.

In accordance with some embodiments, the shaping station 11 comprises respectively first and second holding and shaping means 15, 16 able to hold the pre-shaped pouch PS in two directions incident to each other, advantageously orthogonal, and to allow the opening of the pre-shaped pouch PS in order to make the containing chamber V available.

According to some embodiments described here as a non-limiting example, the first holding and shaping means 15 comprise a pair of grippers 15a able to hold the pre-shaped pouch PS in a first shaping direction X. The second holding means 16 comprise a pair of suckers 16a able to adhere to two opposite faces of the lateral wall 111 of the pre-shaped pouch PS in a second shaping direction Y, transverse with respect to the first shaping direction X.

The first shaping direction X passes through the lateral sealing lines 116 and is substantially orthogonal to the axis of insertion Z, while the second shaping direction Y is substantially orthogonal to the first shaping direction X and orthogonal to the axis of insertion Z. The first shaping direction X and the second shaping direction Y are incident with each other, and the axis of insertion Z passes through the point of incidence.

In the embodiment shown by way of example in FIG. 2a, the grippers 15a are configured to hold the pre-shaped pouch PS and to perform a reciprocal movement toward each other and toward the axis of insertion Z in the first shaping direction X, while at the same time the suckers 16a hold the pre-shaped pouch PS and perform a reciprocal movement away from each other and away from the axis of insertion Z in the second shaping direction Y. In this way, the pre-shaped pouch PS passes from the flat configuration as above to an open configuration, that is, to a configuration in which the containing chamber V is shaped, defining a volume substantially equal to the final volume of the containing chamber V of the pouch S.

It is understood that many other embodiments of the first and second holding and shaping means 15, 16 can be provided, all technically equivalent to those described above and all falling within the field and scope of the present invention.

In accordance with other possible embodiments, the second holding and shaping means 16 can comprise, instead of the suckers 16a, or in combination therewith, also small grippers which hold the flaps of the pouch and force its opening. This solution is very advantageous especially for rigid pouches or pouches made with a material, or a texture, which makes suction by the suckers 16a difficult. In some cases, the second holding and shaping means 16 can comprise both the suckers 16a and also the small grippers: the suckers 16a open the flaps by very little, but just enough to facilitate the secure grip of the small grippers, which create the actual aperture.

In accordance with further possible embodiments, in the event the material that the pouch is made of has magnetic properties, the second holding and shaping means 16 can possibly comprise holding means of the magnetic type.

In accordance with some embodiments, the sealing station 12 comprises sealing means 18 aligned with the insertion rod 13 and mobile along the axis of insertion Z in order to pass from an inactive or stand-by position to a sealing position, in which they are able to abut against the positioning plate 117b, with respect to an external surface 112b of the bottom wall 112, opposite the internal surface 112a, so as to permanently associate the positioning plate 117b with the internal surface 112a of the bottom wall 112.

According to some embodiments, with particular reference to the attached drawings, the sealing means 18 comprise a sealing head 19 and members for positioning and moving the latter (not shown).

The sealing head 19 comprises at least one sealing ring 19a having a shape mating with that of the positioning plate 117b and configured to abut against and seal the positioning plate 117b onto the internal surface 112a of the bottom wall 112. The sealing ring 19a can be heated in a known way and, when it is in contact with the external surface 112b of the bottom wall 112 in a position aligned with the positioning plate 117b, it allows to join the latter by sealing to the internal surface 112a of the bottom wall 112.

In particular, when the sealing means 18 are in the sealing position, the insertion rod 13 is in an insertion and contrast position so that the nozzle 117 is held sandwiched between the insertion rod 13 and the sealing means 18.

In accordance with the example embodiment described here, the sealing head 19 can be configured as a single cylindrical body provided with a flat upper edge, defining the sealing ring 19a, and with a seating 19b configured to accommodate the neck 117a of the nozzle 117 during the sealing operation.

In accordance with possible embodiments, the machine can comprise a subsequent station for filling the containing chamber V with the desired product, a sealing station configured to seal, for example by sealing, the aperture 114 of the pre-shaped pouch PS, and a capping station, possibly upstream of a station for delivering a specific product, configured to apply a cap 119 of a known type to the nozzle 117. In some possible embodiments, the cap 119 applied can define a resting surface for the pouch S which can therefore be disposed resting on the cap upside down, as shown in FIG. 6.

Preferably, the machine described so far is separate from each machine configured to carry out the steps for the production of the pre-shaped pouch PS. In this way, the production steps of the pre-shaped pouch PS and the subsequent steps subject of the present application are carried out separately, so that the machine according to the present invention is constructively simpler than those known in the state of the art, and allows to produce pouches S with shorter cycle times in order to increase productivity and lower production costs.

In accordance with some embodiments, a method to produce a stand-up pouch S is provided which can be put into practice with the machine described above.

The method provides to make at least one singularized pre-shaped pouch PS available to a shaping station 11, initially having a flat configuration and being defined by the lateral wall 111 and by the bottom wall 112 provided with the hole 113. The pre-shaped pouch PS is accessible in correspondence with the aperture 114 opposite the bottom wall 112. The pre-shaped pouch PS is disposed so that the hole 113 is disposed along the axis of insertion Z, preferably coaxial thereto.

The method subsequently provides to manipulate the pre-shaped pouch PS with first and second holding and shaping means 15, 16 respectively, which hold the pre-shaped pouch PS in two directions incident with each other, respectively in the first shaping direction X and in the second shaping direction Y. The first holding means 15 move toward each other in the first shaping direction X and the second holding means 16 move away from each other in the second shaping direction Y, so as to shape the pre-shaped pouch PS defining a containing chamber V thereof.

It should be noted that, advantageously, due to the initial configuration of the pre-shaped pouch and in particular of the bottom wall 112, which is already flat or substantially flat, the step of manipulating and shaping the pre-shaped pouch PS as above does not provide to dispose the bottom wall 112 in a flat configuration, but rather to displace and/or orient such bottom wall 112 in a pre-established position, for example substantially perpendicular to the axis of insertion Z, or transverse to it, so as to be more easily affected by the insertion rod 13 or by the delivery mean 117 in the following step.

Subsequently, the method provides to move the insertion rod 13 along the axis of insertion Z, through the aperture 114, inside the containing chamber V just defined, in order to position, and temporarily keep in position, the delivery mean 117 in correspondence with the hole 113 of the pre-shaped pouch PS.

In a subsequent step, the method provides to move the heated sealing means 18 along the axis of insertion Z in the opposite sense to the direction of insertion of the insertion rod 13, so as to abut against the insertion rod 13 which is keeping the delivery mean 117 in position, so as to heat the delivery mean 117 and the bottom wall 112 in order to join the delivery mean 117 to the bottom wall 112.

The first holding and shaping means 15 comprise the pair of grippers 15a which holds the pre-shaped pouch PS in the first shaping direction X in correspondence with the opposite lateral sealing lines 116.

The second holding and shaping means 16 can be selected from a group consisting of suckers 16a, small grippers, magnetic holding means, adhesive holding means, or other known means. In the example described here, the second holding and shaping means 16 are represented as a pair of suckers 16a which adheres to two opposite faces of the lateral wall 111 in the second shaping direction Y and allows a partial opening of the pre-shaped pouch PS.

In particular, the grippers 15a perform a reciprocal movement toward each other and toward the axis of insertion Z in the first shaping direction X while, simultaneously or in a subsequent/previous instant, the suckers 16a perform a reciprocal movement away from each other and away from the axis of insertion Z in the second shaping direction Y.

In accordance with some embodiments, the insertion rod 13 is equipped with the gripping and positioning means 14 which hold and position the delivery mean 117 so that the neck 117a of the delivery mean 117 passes through the hole 113, and the positioning plate 117b rests on the internal surface 112a of the bottom wall 112, around the hole 113.

In accordance with some embodiments, during the movement of inserting the insertion rod 13 inside the pre-shaped pouch PS through the aperture 114, the insertion rod 13 reaches an end-of-travel position in which it thrusts at least against the bottom wall 112, determining an at least partial stretching of the bottom wall 112. The bottom wall 112 can be completely stretched, assuming a substantially flat development orthogonal to the axis of insertion Z in correspondence with the hole 113, when the sealing means 18 contrast the insertion rod 13.

In accordance with some embodiments, the sealing means 18 are moved along the axis of insertion Z, from the inactive or stand-by position to the sealing position in which they abut against the positioning plate 117b in correspondence with the external surface 112b of the bottom wall 112, around the hole 113, so as to permanently associate the positioning plate 117b with the internal surface 112a of the bottom wall 112.

In particular, when the sealing means 18 are in the sealing position, the insertion rod 13 is in the insertion and contrast position, in which the gripping and positioning means 14 place the delivery mean 117 keeping it temporarily in position in correspondence with the hole 113 so that the delivery mean 117 is held sandwiched between the insertion rod 13 and the sealing means 18.

In accordance with some embodiments, the sealing means 18 comprise the sealing head 19 provided with the sealing ring 19a. The sealing head 19 is moved in order to abut against and seal the positioning plate 117b on the internal surface 112a of the bottom wall 112, the sealing ring 19a being heated so that when it is in contact with the external surface 112b of the bottom wall 112 in a position aligned and coaxial with the positioning plate 117b, allowing to attach the latter to the internal surface 112a of the bottom wall 112.

In accordance with possible embodiments, the method can subsequently provide a step of filling the containing chamber V with the desired product, a step of sealing the aperture 114 of the pre-shaped pouch PS and a capping step in which a cap, of a known type, is applied to the delivery mean 117, on the neck 117a, so as to produce the stand-up pouch S as above.

It should be noted that, preferably, the method described above is carried out in a separate machine with respect to the previous steps in order to produce the pre-shaped pouch PS provided in the initial step of the method as above.

It is clear that modifications and/or additions of parts or steps may be made to the method to produce a stand-up pouch and corresponding machine for producing a stand-up pouch as described heretofore, without departing from the field and scope of the present invention as defined by the claims.

It is also clear that, although the present invention has been described with reference to some specific examples, a person of skill in the art shall certainly be able to achieve many other equivalent forms of a method to produce a stand-up pouch and corresponding machine for producing a stand-up pouch, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. Method to produce a stand-up pouch (S) equipped with a delivery mean (117) configured to allow the delivery of substances or products intended to be contained in the pouch (S), said method providing to:
make available, in a station (11) for shaping the pouch (S), at least one singularized pre-shaped pouch (PS) initially having a flat configuration and being defined by a lateral wall (111), by a bottom wall (112) provided with at least one hole (113), said pre-shaped pouch (PS) being accessible in correspondence with an aperture (114) opposite said bottom wall (112), said pre-shaped pouch (PS) being positioned so that said hole (113) is disposed along an axis of insertion (Z) of said delivery mean (117),
manipulate said pre-shaped pouch (PS) by means of holding and shaping means (15, 16) so as to shape said pre-shaped pouch (PS) defining a containing chamber (V) thereof,
move an insertion rod (13) along said axis of insertion (Z), through said aperture (114), inside said containing chamber (V), in order to position, and temporarily hold in position, said delivery mean (117) in correspondence with said hole (113).

2. Method as in claim 1, characterized in that during the movement of the insertion rod (13), it is provided to hold and position the delivery mean (117) by means of gripping and positioning means (14) with which said insertion rod (13) is equipped, so that a neck (117a) of said delivery mean (117) passes through said hole (113) and a positioning plate (117b) of said delivery mean (117), perimetrically defined around said neck (117a), rests on an internal surface (112a) of said bottom wall (112) around said hole (113).

3. Method as in any claim hereinbefore, characterized in that during the insertion movement of said insertion rod (13) inside the pre-shaped pouch (PS) through said aperture (114), said insertion rod (13) reaches an end-of-travel position in correspondence with which it thrusts at least against the bottom wall (112) determining an at least partial stretching of said bottom wall (112).

4. Method as in any claim hereinbefore, characterized in that it provides to move heated sealing means (18) along said axis of insertion (Z) in a direction opposite the direction of insertion of said insertion rod (13) so as to abut against said insertion rod (13), which is keeping said delivery mean (117) in position, so as to heat part of said bottom wall (112) and said delivery mean (117) making it integral with said bottom wall (112).

5. Method as in claim 4, characterized in that said sealing means (18) are moved along said axis of insertion (Z) from an inactive or stand-by position, to a sealing position in which they abut against a positioning plate (117b) of said delivery mean (117) in correspondence with an external surface (112b) of said bottom wall (112) around said hole (113), so as to permanently associate said positioning plate (117b) with an internal surface (112a) of said bottom wall (112), opposite said external surface (112b).

6. Method as in claim 5, characterized in that when said sealing means (18) are in the sealing position, said insertion rod (13) is in an insertion and contrast position, in which said gripping and positioning means (14) place said delivery mean (117) keeping it temporarily in position in correspondence with said hole (113) so that said delivery mean (117) is held sandwiched between said insertion rod (13) and said sealing means (18).

7. Method as in claim 4, 5 or 6, characterized in that said sealing means (18) comprise a sealing head (19) provided with a sealing ring (19a) having a shape mating with that of said positioning plate (117b), said sealing head (19) being moved in order to abut against and seal said positioning plate (117b) on the internal surface (112a) of said bottom wall (112), said sealing ring (19a) being heated so that, when the sealing ring (19a) is in contact with the external surface (112b) of the bottom wall (112) in a position aligned and coaxial with the positioning plate (117b), it allows to join the latter to the internal surface (112a) of the bottom wall (112).

8. Method as in any claim hereinbefore, characterized in that the holding and shaping means comprise first and second holding and shaping means (15, 16) which hold the pre-shaped pouch (PS) in two directions incident with each other, respectively in a first shaping direction (X) and in a second shaping direction (Y).

9. Method as in claim 8, characterized in that said first shaping direction (X) is substantially orthogonal to said axis of insertion (Z), and in that said second shaping direction (Y) is substantially orthogonal to said first shaping direction (X) and orthogonal to said axis of insertion (Z).

10. Method as in either claim 8 or 9, characterized in that during the step of manipulating the pre-shaped pouch (PS), the first holding and shaping means (15) move toward each other in the first shaping direction (X) and the second holding and shaping means (16) move away from each other in the second shaping direction (Y), or vice versa.

11. Method as in any claim hereinbefore, characterized in that the bottom wall (112) of the pre-shaped pouch (PS) is flat or substantially flat when said pre-shaped pouch (PS) is made available in the shaping station (11).

12. Method as in claim 11, characterized in that during the step of manipulating the pre-shaped pouch (PS), the bottom wall (112) is displaced and/or oriented in a transverse position, preferably perpendicular, to the axis of insertion (Z).

13. Method as in any claim hereinbefore, characterized in that it is carried out in a machine separate from the machine in which the pre-shaped pouch (PS) was produced.

14. Machine for producing a stand-up pouch (S) able to carry out the method as in any claim hereinbefore, said machine comprising at least one shaping station (11) provided at least with:
holding and shaping means (15, 16) configured to shape a singularized pre-shaped pouch (PS) defining a containing chamber (V) thereof, said holding and shaping means (15, 16) comprising first (15) and second holding and shaping means (16) configured to hold the pre-shaped pouch (PS) in two directions incident with each other, respectively in a first shaping direction (X) and in a second shaping direction (Y).
an insertion rod (13) having a development along an axis of insertion (Z) and being mobile along said axis of insertion (Z) in order to position, and temporarily maintain in position, inside said containing chamber (V) a delivery mean (117) in correspondence with a hole (113) provided in a bottom wall (112) of said pre-shaped pouch (PS).

15. Machine as in claim 14, characterized in that the first shaping direction (X) is substantially orthogonal to the axis of insertion (Z) and in that the second shaping direction (Y) is substantially orthogonal to the first shaping direction (X) and orthogonal to the axis of insertion (Z).
